(19) United States
(12) Patent Application Publication
(10) Pub. No.: US 2023/0259443 A1
(43) Pub. Date: Aug. 17, 2023

(54) CHARACTERIZING A COMPUTERIZED SYSTEM WITH AN AUTOENCODER HAVING MULTIPLE INGESTION CHANNELS

(71) Applicant: INTERNATIONAL BUSINESS MACHINES CORPORATION, ARMONK, NY (US)

(72) Inventors: Mircea R. Gusat, Langnau am Albis (CH); Lili Lyubchova Georgieva, Sofia (BG); Charalampos Pozidis, Thalwil (CH); Serge Monney, Pully (CH)

(21) Appl. No.: 17/651,391

(22) Filed: Feb. 16, 2022

(51) Int. Cl. G06F 11/34; G06F 11/07

(52) U.S. Cl. CPC G06F 11/3495; G06F 11/0751; G06F 11/0721

(57) ABSTRACT

The invention is directed to characterizing a computerized system. Access key performance indicators (KPIs), for the computerized system. Each of the KPIs is a timeseries of KPI values and is categorized into one of n types. KPI values are channeled through n buffer channels. Each buffer channel buffers KPI values of one of n types. Finally, reconstructions errors are obtained by feeding initial KPI values to n respective input channels of a cognitive model, implemented as an autoencoder by a trained neural network including an encoder and a decoder. Encoder has temporal convolutional layer blocks connected by each input channel. Decoder has deconvolution layer blocks connected by encoder. Initial KPI values are independently processed in n input channels, then compressed by encoder, prior to being reconstructed by decoder. Reconstruction errors are obtained by comparing reconstructed KPI values with initial KPI values. Computerized system is characterized based on reconstruction errors obtained.

The document “Cloud Causality Analyzer for Anomaly Detection”, Swiss Federal Institute of Technology Zurich, Master Thesis, was authored by Lili L. Georgieva, co-inventor of the present invention, and published on Apr. 14, 2021. This document was prepared under advisement of Mircea R. Gusat (also known as Mitch Gusat), co-inventor of the present invention.

### BACKGROUND

The invention relates in general to the field of computer-implemented methods, characterization systems, and computer program products for characterizing computerized systems. In particular, it is directed to methods that process key performance indicators (KPIs) for the computerized system through a cognitive model implemented as an autoencoder by a trained neural network, to characterize the computerized system.

In recent years, explainability and causality have been the subject of increasing interest in the machine learning community. Given the proliferation of complex, black-box neural network models, many called for the need to explain model predictions and deepen the causal discovery of true causes of predicted outcomes. In particular, one important area in the cybersecurity and cloud computing domain is anomaly detection (AD), which relates to the identification of rare or unexpected events or data patterns in computerized systems. Beyond anomaly detection, it is often necessary to be able to aptly characterize such computerized systems.

Various application—and data-specific statistical and deep learning models have been proposed for characterizing computerized systems, in particular for anomaly detection. Explainability methods generally fail to drill in deeper from causal inference of symptoms to root cause analysis (RCA)—inferring the faults that generated the observed symptoms—while baseline causality methods suffer from inefficiency and scalability issues when run on large datasets.

### SUMMARY

According to a first aspect, the present invention is embodied as a computer-implemented method of characterizing a computerized system. The method first comprises accessing key performance indicators, or KPIs, for the computerized system. Each of the KPIs is a timeseries of KPI values and is categorized into one of n types of KPIs, where n≥2. The KPI values of the KPIs are then channeled through n buffer channels, in accordance with the n types. That is, each of the n buffer channels buffers KPI values of KPIs of a respective one of the n types. Finally, reconstructions errors are obtained by feeding initial KPI values, as buffered in the n buffer channels, to n respective input channels of a cognitive model. The cognitive model is implemented as an autoencoder by a trained neural network. The autoencoder includes an encoder and a decoder. The encoder has temporal convolutional layer blocks connected by each of the n input channels. The decoder has deconvolution layer blocks connected by the encoder. The initial KPI values are independently processed in the n input channels, then compressed via the temporal convolutional layer blocks of the encoder, prior to being reconstructed via the deconvolution layer blocks of the decoder. The reconstruction errors are obtained by comparing the reconstructed KPI values with the initial KPI values. Eventually, the computerized system is characterized based on the reconstruction errors obtained.

According to another aspect, the invention is embodied as a characterization system for characterizing a computerized system of interest. The characterization system comprises a communication unit configured to access data from the computerized system, as well as a processing unit. The latter is connected to the communication unit and configured to perform steps as described above, i.e., accessing KPIs, channeling KPI values through n buffer channels, and obtaining reconstructions errors via the cognitive model, which is implemented as an autoencoder by a trained neural network.

According to a final aspect, the invention is embodied as a computer program for characterizing a computerized system. The computer program product comprises a computer readable storage medium having program instructions embodied therewith. The program instructions are executable by processing means to cause the latter to take steps according to the method described above.

### BRIEF DESCRIPTION OF THE DRAWINGS

These and other objects, features and advantages of the present invention will become apparent from the following detailed description of illustrative embodiments thereof, which is to be read in connection with the accompanying drawings. The illustrations are for clarity in facilitating one skilled in the art in understanding the invention in conjunction with the detailed description. In the drawings:

FIG. 1 schematically illustrates a characterization system interacting with a computerized system of interest, as in embodiments. FIG. 3 is a functional diagram illustrating selected components of and tasks performed by this characterization system, as in embodiments. The characterization system may notably be embodied as a general-purpose computerized system such as depicted in FIG. 5;

FIG. 2 is a flowchart illustrating high-level steps of a method of characterizing a computerized system, according to embodiments; and

FIG. 4 schematically depicts the structure of a neural network with two input channels, where the neural network implements an autoencoder, as in embodiments.

The accompanying drawings show simplified representations of devices or parts thereof, as involved in embodiments. Similar or functionally similar elements in the figures have been allocated the same numeral references, unless otherwise indicated.

Characterization systems, computer-implemented methods, and computer program products embodying the present invention will now be described, by way of non-limiting examples.

### DETAILED DESCRIPTION OF EMBODIMENTS OF THE INVENTION

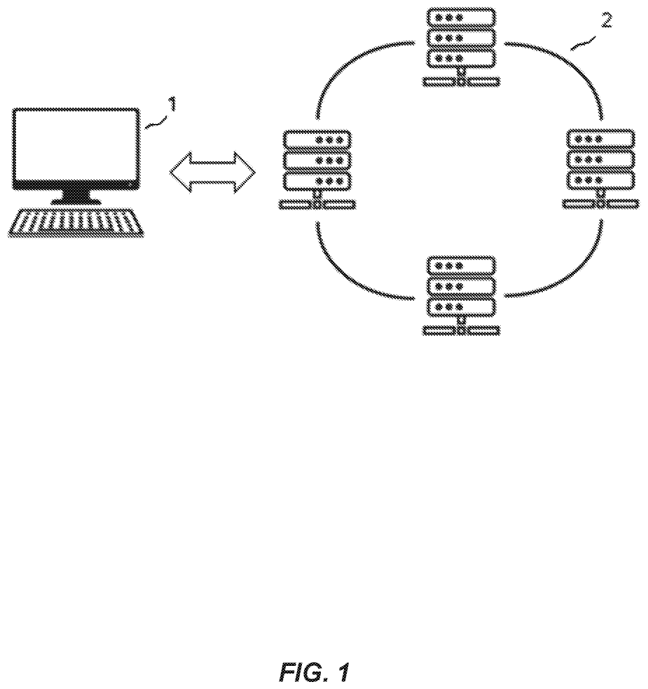

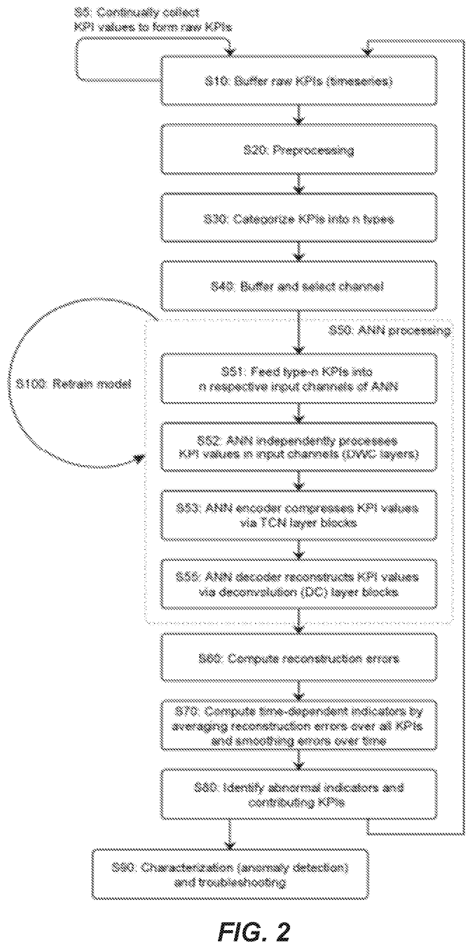

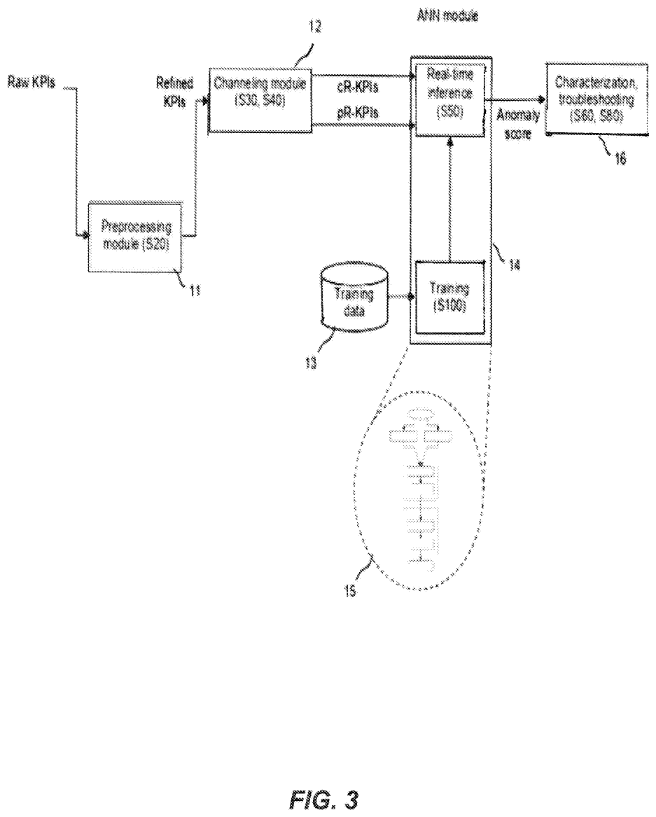

The following description is structured as follows. First, general embodiments and high-level variants are described in section 1. Section 2 addresses particularly preferred embodiments and section 3 concerns technical implementation details. Note, the present method and its variants are collectively referred to as the “present methods”. All references Sn refer to methods steps (FIGS. 2 and 3), while numeral references pertain to physical parts, components, and concepts involved in the present characterization systems (FIGS. 1, 4, and 6).

### 1. General Embodiments and High-Level Variants

In reference to FIGS. 1-4, a first aspect of the invention is now described in detail, which concerns a computer-implemented method of characterizing a computerized system 2 based on key performance indicators (KPIs) for this computerized system 2. The KPIs are typically obtained from compute devices and/or storage devices composing the system 2.

First, KPIs are accessed. Each KPI is a timeseries, i.e., a series of values (here called KPI values) of a quantity obtained at successive times. Such KPI values may for instance be continuously collected and aggregated (see step S5 in FIG. 2) from data streams of raw KPI values, and then buffered at step S10. The aggregated values are typically subject to some preprocessing (step S20), as discussed later in reference to particular embodiments.

According to the present approach, the KPIs are categorized, before being fed to a cognitive model 15 for characterizing the target system 2. More precisely, each KPI is categorized S30 into one of n types of KPIs, where n≥2. This categorization is preferably achieved thanks to a clustering process, which is described later in detail.

Next, KPI values of the KPIs are channeled S40 through n buffer channels, in accordance with the n types of KPIs identified earlier. That is, each of the n buffer channels buffers KPI values of KPIs of a respective one of the n types. Each buffer channel is basically a memory for temporarily storing values of the KPIs. I.e., the buffer channels store KPIs with a view to subsequently injecting the stored KPI values in input channels of a cognitive model 15, in order to characterize the system 2 based on outputs of the model 15. I.e., the KPI values buffered in the n buffer channels serve as input data for the cognitive model 15 and are referred to as “initial KPI values” in the following.

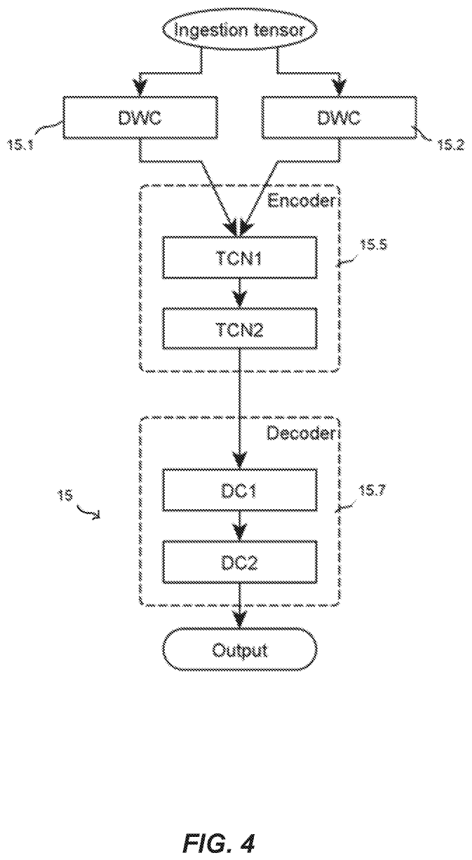

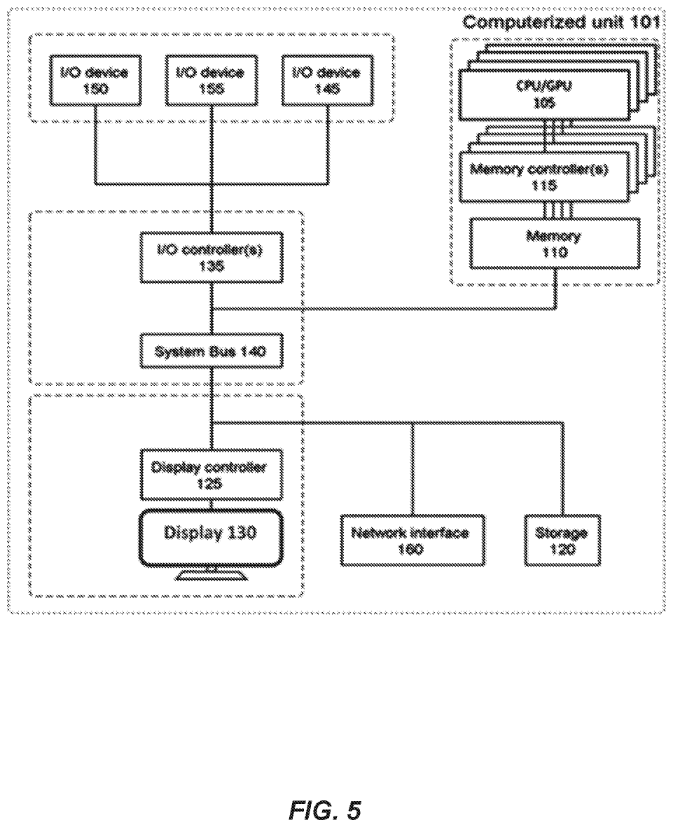

General step S50 concerns processing performed by the cognitive model 15. It decomposes as follows. At step S51, the initial KPI values (as buffered in then buffer channels) are fed to n respective input channels 15.1, 15.2 of the cognitive model 15. The latter is implemented as an autoencoder by a trained neural network 15, i.e., an artificial neutral network (ANN). The autoencoder notably includes an encoder 15.5 and a decoder 15.7. Basically, the ANN 15 processes the initial KPI values to produce output values, based on which reconstructions errors are obtained S50-S60. Remarkably, the encoder 15.5 includes temporal convolutional layer blocks TCN1, TCN2. The latter are connected by each of the n input channels 15.1, 15.2, as seen in FIG. 4. Consistently, the decoder 15.7 includes deconvolution layer blocks DC1, DC2, which are connected by the encoder 15.5. I.e., input channels connect to the encoder, which connects to the decoder. The ANN 15 is configured in such a manner that the initial KPI values are independently processed S52 in the n input channels 15.1, 15.2, then compressed S53 via the temporal convolutional layer blocks TCN1, TCN2 of the encoder 15.5, prior to being reconstructed S55 via the deconvolution layer blocks DC1, DC2 of the decoder 15.7.

Eventually, reconstruction errors are obtained S60 by comparing the reconstructed KPI values with the initial KPI values. I.e., reconstructs from the latent space of the autoencoder are exploited to compute reconstruction errors. This, in turn, makes it possible to characterize S70-S90 the computerized system 2 based on the reconstruction errors obtained, in an unsupervised manner.

The proposed approach enables an unsupervised pipeline, which exploits reconstruction errors obtained for KPIs channeled through multiple input channels 15.1, 15.2 of the ANN 15 for characterizing the target computerized system 2, e.g., to detect an anomaly in the system 2 and, if necessary, to troubleshoot the target system 2, as in embodiments described later in detail. The present approach may for instance be used to monitor general-purpose computers, datacenters, clouds, supercomputers, as well as memory and storage hardware, and load/store engines.

As the present inventors realized, the proposed architecture (in particular the temporal convolutional blocks and deconvolution counterparts) has advantages in terms of interpretability (explainability), scalability, and root cause analysis (RCA), as further explained throughout this document.

The encoder 15.5 compresses the input KPIs into a latent space manifold that encodes the essential signal and then process it via the decoder 15.7, which attempts to reconstruct the initial KPIs from their compressed representations. Moreover, the cognitive model 15 may possibly ingest a frontend data stream, which may already be compressed, e.g., by way of a selection of most representative KPIs. Still, the cognitive model 15 allows additional compression to be achieved in its latent space, which is exploited for characterizing the system 2. The latent space manifold preferably involve 32 to 128 neurons (more preferably 64 neurons), as opposed to the hundreds to thousands nodes used in input.

The temporal convolutional layer blocks TCN1, TCN2 allow temporality to be taken into account, in addition to spatial correlations between the KPIs. The TCN blocks enable interpretability inasmuch as dilation factors, even small, can directly be related to causality lags, a thing that is not possible with non-dilated convolutional models. In a causality context, non-linear neural networks have advantages as they allow to go beyond pairwise co-determination algorithms of prior methods. Furthermore, the proposed approach makes it possible to relax KPI constraints in terms of strict stationarity and linear time-invariance that prior methods often impose.

The data aggregation and categorization can be performed repeatedly, so as to continually feed the cognitive model 15 with data and continually characterize the system 2 of interest, possibly in (near) real-time. I.e., KPI values may possibly be continually fed into respective input channels of the cognitive model 15. Thus, the present methods may be implemented as an anomaly detection method to detect potential anomalies in (near) real-time. However, the present methods may also be performed on specific occasions, e.g., in respect of past timeseries, to detect past anomalies in the system 2 (e.g., for forensic purposes).

The range of KPIs considered for categorization may typically include between 50 and 260 KPIs, initially. However, one preferably considers between 70 and 130 KPIs, e.g., approximately 100 KPIs. The KPIs are computed based on data collected (e.g., streamed) S5 from the computerized system 2 of interest. The KPIs may be formed using any suitable metric. Such KPIs may for instance relate to CPU utilizations, read/write response times, and read/write input/output (I/O) rates. Other KPIs may for instance relate to access rights, disk-to-cache transfer rates or, conversely, cache-to-disk transfer rates, possibly using volume cache (VC) or volume copy cache (VCC) metrics for volumes. In practice, however, cache-related KPIs are found to be less useful than read/write data in the present context. Other types of KPIs are known to the skilled person.

The KPIs may be streamed and sampled at any suitable frequency, e.g., 288 times per day, i.e., every 300 seconds (every 5 minutes). The duration of the period used to train the model 15 may for instance be 1, 3, or 6 months. Higher frequencies and/or longer periods may be contemplated in the present context.

The KPIs are formed S5-S10 as timeseries, i.e., as objects of the form {. . . , x_{1,t-2}, x_{1,t-1}, x_{1,t}}, . . . , {. . . , X_{n,t-2}, x_{n,t-1}, X_{n,t}}} where {. . . , x_{1,t-2}, x_{1,t-1}, x_{1,t}} denote values obtained at distinct time points for a same KPI x₁, while x₁, . . . , xₙ denote distinct KPIs. The timeseries can be aggregated S5 based on data collected at regular time intervals from the system 2. Still, the collected data may possibly be up/sub-sampled, in order to form the timeseries. E.g., one may need to interpolate and/or extrapolate the timeseries for the timeseries values of the various KPIs to correspond to same time points, as in embodiments. In that case, the input array considered for clustering may be of the form {{t₁, t₂, . . . , tₘ}, {x₁₁, x₁₂, . . . , x₁ₘ}, {x₂₁, x₂₂, . . . , x₂ₘ}, . . . , {xₖ₁, xₖ₂, . . . , xₖₘ}}. Still, the clustering algorithm preferably operates based on the sole KPI values {{x₁₁, x₁₂, . . . , x₁ₘ}, {x₂₁, x₂₂, . . . , x₂ₘ}, . . . , {xₖ₁, xₖ₂, . . . , xₖₘ}}, while the time-related data are stored for later use, notably to identify critical time points, as explained later.

Some of the initial KPIs may possibly be discarded, after the preprocessing step S20. At step S30, the KPIs are categorized S30 as objects of n respective types, i.e., as objects having different properties as per the procedure used to identify them. Now, the categorization performed at step S30 may advantageously involve substantial precompression, thanks to a clustering process and a selection of representative KPIs in each cluster. Namely, after the preprocessing S30, the KPIs may be clustered S30, so as to obtain k clusters, where k≥2. Each cluster includes at least m KPIs, where m>n. That is, each cluster should include a number m of KPIs that is larger than the number n of input channels, for reasons that will become apparent below. Next, representative KPIs can be identified in each of the clusters formed. That is, for each cluster of the k clusters obtained thanks to the clustering process, n representative KPIs are identified in each cluster. The representative KPIs are identified as objects of distinct types. Finally, KPI values of the n representative KPIs identified can be buffered in respective ones of the n buffer channels.

The representative KPIs are preferably identified so as to exhibit antagonistic or contrasting properties, as per the metric used to identify them. Preferred is to select a central KPI and a peripheral KPI in each cluster. That is, the n representative KPIs identified in each cluster may include a central KPI (cR-KPI) and a peripheral KPI (pR-KPI) of this cluster, e.g., the most central and the most peripheral KPIs. For example, the KPIs can be ordered in each cluster according to their distances to the centroid of that cluster, which makes it possible to easily determine the representative KPIs. Preferably, use is made of the most central KPI and the most peripheral KPI only, such that only two buffer channels and two inputs channels are needed in that case. The most central and the most peripheral KPIs can be regarded as statistically normal and abnormal KPIs, respectively.

In preferred embodiments, the KPIs are iteratively clustered S30 thanks to a k-shape algorithm. The k-shape clustering algorithm is a robust, iterative refinement algorithm that scales linearly with the number of features and creates k-well-separated, homogeneous clusters. This clustering process is iterative: the algorithm first randomly initializes the timeseries' assignments to clusters and then iteratively updates the assignments based on distances to the cluster centroids. In practice, one preferably seeks to obtain 8 to 10 clusters, eventually. The k-shape algorithm relies on the so-called shape-based distance (SBD), which uses a normalized cross-correlation (NCC) measure that compares the shapes of the timeseries shapes and hence can detect pairwise similarities, even for lagged (non-simultaneous) co-dependencies.

In variants, one may select different types of KPIs at step S30 (i.e., other than the central and peripheral KPIs), provided that the KPIs selected remain sufficiently representative of each cluster. For example, the representative KPIs may be selected as follows. In each cluster, one first selects a subset of n KPIs that are the closest to the average radial distance to the centroid. In that sense, the n KPIs selected are representative of this cluster. Then, one categorizes the n KPIs selected into n different types, in accordance with their respective distances to n axes spanning a n-dimensional space, where the n axes may for instance be determined by principal component analysis. Other algorithms may similarly be designed, to select n representative KPIs in each cluster.

Next, the algorithm may aggregate timeseries corresponding to representative KPIs of each type. I.e., representative KPIs of a given type form a set {{xⱼ₁, xⱼ₂, . . . , xⱼₘ}, {xₖ₁, xₖ₂, . . . , xₖₘ}, . . . }, where {xⱼ₁, xⱼ₂, . . . , xⱼₘ} corresponds to one representative KPI of that given type. The corresponding KPIs are then fed into a respective input channel of the neural network 15. In other words, n-uplets of KPIs are identified, and the KPIs of each n-uplet is subsequently fed into the nth input channel of the cognitive model 15. Time data do typically not need to be fed into the model, because they do not provide learnable information. However, they are typically saved, in order to later map the anomalous indices detected to time points, e.g., when investigating incidents.

In principle, one may have any number n of input channels, provided that this number is smaller than the average number of KPIs in each cluster. That is, if k clusters of KPIs are identified, which, on average, include M KPIs, then n must be strictly smaller than M. To that aim, one may need to adapt the number k of clusters formed to ensure that a sufficiently large number of KPIs are included in each cluster. That said, the number n of channels is preferably chosen to be small, to increase the compression achieved through the clustering and selection process.

The number n of channels is preferably chosen to be equal to 2 (i.e., n=2). In that case, the two representative KPIs identified for each cluster may correspond to the most central KPI (cR-KPI) and the most peripheral KPI (pR-KPI) in this cluster. This means that the buffer channels consists of two buffer channels only. Similarly, the input channels of the neural network 15 consists of two input channels 15.1, 15.2 only, i.e., a first input channel 15.1 and a second input channel 15.2, as assumed in FIG. 4. Thus, the central KPIs of the k clusters can be buffered S40 in a first buffer channel and fed S51 into the first input channel 15.1, while peripheral KPIs of the k clusters are buffered S40 in a second buffer channel and fed S51 into the second input channel 15.2. For example, two data streams of representative KPIs (central and peripheral KPIS) can be formed, from which two compressed channels (the buffer channels) are built, which are later ingested by the cognitive model 15. Combining the k-shape clustering algorithm with a two-channel extraction (for central and peripheral representative KPIs only) allows a particularly efficient compression to be achieved.

In variants, the number n of channels may for instance be chosen to be equal to 4 (i.e., n=2). In that case, two channels may be used to respectively ingest central and peripheral KPIs, while the two remaining channels are used to respectively ingest read and write data in parallel. This leads to noticeable improvements over the previous example, albeit at a higher computational costs. Whether to use four instead of two channels can be decided by a cost/benefit analysis. More generally, one may similarly use any number of pair of channel. Still, the performance achieved with only two channels buffering central and peripheral KPIs will likely be satisfactory in most applications. Therefore, the following embodiments mostly assume a two-channel configuration as described above.

In addition, a frequency-based aggregation mechanism can be used, whereby the most frequently occurring KPIs are selected, e.g., according to a percentage or heuristic. The aggregation mechanism may for instance aggregate weekly representative KPIs that are the most frequently occurring in one month into monthly KPI channels. Applying this to both the central and peripheral representative KPIs yields two monthly channels. Still, the channeling algorithm may ensure that both channels are equally-sized, according to a predefined channel size (e.g., specified by a user). This makes it possible to achieve balance between capturing: (i) the current representative trends, and (ii) the core system behavior during an extended time period. For example, each KPI may be a vector aggregating one week of data (2016 points), corresponding to 5 min time lags. The same procedure can be run for several successive weeks; the most frequent KPIs are then picked up to extract monthly representatives.

In addition, the clusters are preferably ordered by cardinality, prior to feeding S51 the buffered KPIs into the input channels. More precisely, the KPIs (as buffered in each of the two buffer channels) may be ordered in descending order of cardinality of the respective clusters. In other words, the representative KPIs of large clusters are buffered first. In practice, the ingestion tensor may be built cluster-by-cluster, from the largest to the smallest cluster by cardinality number of KPIs in each cluster. That is, one may first sort the clusters by cardinality, then sort and select the KPIs according to their distances to the centroids of the clusters, to select the representative KPIs. The benefit of such an ordering on the model performance can be evaluated at run-time.

The characterization S90 of the computerized system 2 may notably aim at detecting potential anomalies. Formally, anomalies are defined as rare events that are so different from other observations that they raise suspicion concerning the mechanism that generated them. Anomalies may arise due to malicious or improper actions, frauds, or system failures, for example. An anomaly may notably be due to a data traffic anomaly, as with a network attack (e.g., on the business environment), unauthorized access, network intrusion, improper data disclosure, data leakage, system malfunction, or data and/or resources deletion. Anomaly detection is important in various domains, such as cybersecurity, fraud detection, and healthcare. An early detection is often of utmost importance as failing to act upon the causes of the anomaly can cause significant harm.

The detection of an anomaly may lead to (instruct to) take S90 action in respect of the computerized system 2, so as to modify a functioning of the computerized system. Any appropriate decision may be made in the interest of preserving the system and/or its environment. Both the type of action and its intensity may depend on the anomaly score obtained. For example, a preemptive action may be taken, to preempt or forestall adverse phenomena. E.g., in case a substantial anomaly is detected, some of the data traffic may be interrupted, re-routed, deleted, or even selected parts of the computerized system may be shut down, as necessary to deal with the anomaly.

The detection of an anomaly may notably lead to troubleshooting S90 the computerized system 2, e.g., by performing a causal analysis based on a selection of the representative KPIs that have been determined to contribute the most to the anomaly detected. In that respect, reducing the feature space to only a small number of KPIs (as achieved thanks to a pre-compression scheme proposed above) allows support engineers to analyze the system performance behavior more effectively, based on only a fraction of the large number of initial KPIs, and accordingly reduces incident resolution times. Moreover, this feature compression is crucial for scalable causality discovery of root anomalous culprits.

The following explains how the target system 2 is characterized, in preferred embodiments. Referring to FIG. 2, the present methods preferably rely on time-dependent indicators, which are obtained S70 based on the reconstruction errors computed S60 thanks to outputs provided by the ANN 15. The reconstruction errors are typically obtained S60 by computing differences between the reconstructed KPI values and the initial KPI values, for each KPI and for each time point. Next, one may seek to identify S80 abnormal values of the time-dependent indicators obtained. In turn, the computerized system can be characterized S90 based on a selection of the KPIs that are found to contribute the most to the abnormal values identified. For example, the algorithm may pick the top-h KPIs that contribute the most to a given, abnormal value. In variant, the algorithm may select all the KPIs that contribute to more than a given fraction (e.g., 50%) of any abnormal value identified. In both cases, it is possible to automatically identify those KPIs that are responsible for the characterized state of the system 2, which eases the task of support engineers when analyzing the system 2, e.g., to resolve incidents.

The time-dependent indicators may notably be obtained S70 by summing absolute values of the reconstructions errors obtained for the KPI values over all of the KPIs and, this, for each time point. That is, at each time point, the algorithm sums the reconstructions errors obtained for all KPI values corresponding to this time point. In variants, one may sum reconstructions errors obtained for a subset of the KPI values, this resulting in a small performance improvement. Abnormal values can then be identified S80 by detecting those critical time points, at which the time-dependent indicators take abnormal values, e.g., exceed a threshold value.

Note, the algorithm may advantageously smooth the time-dependent indicators over time, to minimize false positives. More precisely, the reconstructions errors may be smoothed S70 over time, after summing them, e.g., by summing the KPI values at each time point and then computing a moving average. This way, the time-dependent indicators are obtained S70 as smoothed values for each time point and the critical time points are identified as points corresponding to time points at which the smoothed values exceed a threshold value.

One may for instance calculate the reconstruction error, for each KPI, as the squared distance between the initial KPI and reconstructed KPI (considered as vectors). The resulting distance can be normalized, e.g., by scaling in the [0, 1] range. Then, the mean error over all KPIs is smoothed over time, e.g., via a moving average function with a rolling a [4-hour] window with a certain overlap to obtain smoothed errors. The overlap may for example amount to 1, 2, or 3 hours. Preferably, a 3-hour overlap is used, which amounts to 75% of the rolling window, to achieve more granularity. In variants, other smoothing functions can be used, such as convolutions or low-pass filters.

In embodiments, the time points are identified S80 according to a K-sigma thresholding method, i.e., based on the mean value μ and the dispersion value σ (e.g., the standard deviation) obtained for the smoothed values. The underlying assumption is that the majority of the data have a normal behavior and, thus, are correctly learned and reconstructed by the cognitive model 15. The K-sigma thresholding method classifies a time point as anomalous if the corresponding smoothed error exceeds μ+K×σ. That is, a timestep t is classified as anomalous if and only if its smoothed error exceeds a threshold set to μ+K×σ. The hyper parameter K controls the tolerance to outliers and is usually set to 2, which corresponds to the 95^{th} percentile of a Gaussian distribution. Finally, for each anomaly, the algorithm may for instance extract the top-f KPI contributors to the anomalous reconstruction error. Consecutive anomalous timepoints are preferably grouped in anomaly windows. In some applications, sustained anomalies (e.g., lasting several hours) may be particularly interesting to track. In such applications, the algorithm may for instance filter out point outliers (short-lived bursts), e.g., lasting less than 15-minutes, as these do typically not require further investigation by the support engineers. In such applications, the outputs provided to the support engineers, at post-proces sing (i.e., downstream the cognitive model 15), may include anomaly windows, together with corresponding top-f KPI contributors.

The following describes preferred architectures of the ANN 15, in reference to FIG. 4. To start with, each of the n input channels 15.1, 15.2 preferably includes one or more depth-wise convolutional (DWC) layers. In that case, the initial KPI values are independently processed S52 in then input channels 15.1, 15.2 by performing depth-wise spatial convolutions separately on each of the n input channels 15.1, 15.2, thanks to the DWC layers. That is, at least one DWC layer is used in each input channel and each DWC layer performs a depth-wise spatial convolution acting on each input channel separately, without mixing the outputs.

Note, the cognitive model 15 may advantageously be trained S100 based on initial weights that are differently scaled in the DWC layers of the n input channels 15.1, 15.2, as assumed in FIG. 2, to speed up the training. That is, the initial weights are distinctly scaled upward or downward in each input channel, in accordance with the types of the categorized KPIs. Doing so amounts to introducing some bias, on purpose, from the start, even though zero biases are typically set in each input channel. For example, the training algorithm may initially put more weight on the input channel corresponding to statistically normal KPIs (e.g., the central R-KPIs) than on the input channel corresponding to statistically abnormal KPIs (e.g., the peripheral R-KPIs), assuming that the target system 2 mostly performs normally. E.g., the input channel corresponding to central KPIs may have weights initially set to 0.7, while the input channel corresponding to peripheral KPIs may have weights initially set to 0.3, assuming weights in the range [0-1].

More generally, the initial weights can be up/down-weighted using simple heuristics. Doing this enables a simplified attention mechanism. Using a more complex attention method may conceptually defeat the explainability purpose of the present approach. Therefore, it is preferred to simply scale the two input channels with custom initialization weights in the DWC layers. Weight scaling heuristics are simple to understand when troubleshooting in a specific time frame, based on prior knowledge or information obtained from tickets, clients, the anomaly detection model, etc.

As further seen in FIG. 4, the encoder 15.5 preferably includes two temporal convolutional layer blocks TCN1, TCN2, while the decoder 15.7 consistently includes two deconvolutional layer blocks DC1, DC2. More preferably, the encoder 15.5 consists of the two blocks TCN1, TCN2, while the decoder 15.7 consists of the two blocks DC1, DC2. This makes it easier to maintain consistency upon reconstructing the KPIs. Indeed, the more deconvolutional blocks the longer it takes to train S100 the model 15, let alone risks in terms of overfit. So, as the present inventors concluded, a good trade-off is to rely on two blocks only, in each the encoder 15.5 and the decoder 15.7. In variants, however, one may contemplate using a larger number of blocks (e.g., three block on each side), notably if the input dataset has a large size.

In preferred embodiments, each block TCN1, TCN2 comprises one or more dilated temporal convolutional filter layers. In addition, each block TCN1, TCN2 will typically include a hierarchy of neural layers in output of the dilated temporal convolutional filter layers, namely a batch normalization layer, an activation layer (typically a Rectified Linear Unit, or ReLU), and a spatial dropout layer. The second block may further include a skip connection convolution from the previous residual block. The dilated temporal convolutional filter layers enable causal convolutions, with increasing dilation factors, e.g., in powers of two, although different dilation factors might be used. In each residual block, two stacks of temporal convolutions are used, which allows the model to learn more complex patterns by flexibly increasing the receptive field. The filter sizes can be gradually reduced in the two TCN blocks, resulting in a much reduced dimensionality in the bottleneck layer.

Another aspect of the invention is now discussed in reference to FIGS. 1 and 5. This aspect concerns a characterization system 1 for characterizing a computerized system 2, as schematically illustrated in FIG. 1. Consistently with the present methods, characterizations are performed based on KPIs for the computerized system 2. As noted earlier, the computerized system 2 may notably be a single computer or a network of interconnected computerized units 25, e.g., forming a cloud. In that case, the nodes 25 may store and deploy resources, so as to provide cloud services for users, which may include companies or other large infrastructures. Note, the characterization system 1 may possibly belong to the target computerized system 2 and include one or more units of that system 2.

In general, the characterization system 1 may include one or more computerized units 101 such as shown in FIG. 5. In the following, we assume that the system 1 consists of a single unit 101, for simplicity. The system 1 notably comprises a communication unit, which is configured to access data from the computerized system 2. The communication unit may for example be formed by a network interface 160 and an input/output (I/O) controller 135; the network interface 160 is connected to the I/O controller 135 via the system bus of the unit 101. The network interface 160 allows the characterization system 1 to receive external data, including data from the computerized system 2; the received data are then handled by the I/O controller.

The system 1 further comprises processing means 105, which are connected to the communication unit. The system 1 typically includes computerized methods in the form of software that is stored in a storage 120. The software instructions can be loaded in the memory 110, so as to configure the processing means 105 to perform steps according to the present methods. In operation, the processing means cause to access KPIs and channel the KPIs through n buffer channels, e.g., by clustering the KPIs, identifying representative KPIs in each cluster, and buffering KPI values of the representative KPIs identified in the buffer channels. In turn, the processing means 105 cause to feed the buffered KPI values into input channels 15.1, 15.2 of the ANN 15 (implementing an autoencoder), to process such values and obtain reconstructions errors, based on which the processing means 105 subsequently characterize the computerized system 2, as explained earlier in reference to the present methods.

In particular, the input channels 15.1, 15.2 of the neural network 15 may be formed by respective sets of neural layers, for the neural network 15 to independently processes S51 the KPIs in the input channels via the respective sets of neural layers. As discussed earlier, each input channels 15.1, 15.2 preferably includes one or more DWC layers. Besides, the encoder 15.5 preferably includes (or even consists of) two temporal convolutional layer blocks TCN1, TCN2, while the decoder 15.7 preferably includes (or even consists of) two deconvolutional layer blocks DC1, DC2. Moreover, each block TCN1, TCN2 preferably comprises one or more dilated temporal convolutional filter layers, for reasons explained earlier. In addition, each block TCN1, TCN2 typically includes a hierarchy of neural layers (i.e., a batch normalization layer, an activation layer, and a spatial dropout layer) in output of the dilated temporal convolutional filter layers.

In the example of FIG. 1, the system 1 is assumed to be distinct from (nodes of) the system 2. That is, the system 1 is adapted to interact with hardware components of the system 2, e.g., with a view to detecting anomalies in this system 2 and instruct to take appropriate actions in respect of the target system 2. In variants, the system 1 may actually form part of the target system 2. In that case, the tasks performed by the characterization system 1 may for instance be delocalized over nodes of the system 2. Other entities (not shown) may possibly be involved, such as traffic monitoring entities (packet analyzers, etc.). Additional features of the system 1 are described in section 3.1.

Next, according to a final aspect, the invention can be embodied as a computer program product for characterizing a computerized system 2. The computer program product comprises a computer readable storage medium having program instructions embodied therewith. Such instructions typically form a software, e.g., stored in the storage 120 of the system 1 described above. The program instructions can be executed by processing means 105 of such a system 1 to cause the latter to perform steps according to the present methods. Additional features of this computer program product are described in section 3.2.

The above embodiments have been succinctly described in reference to the accompanying drawings and may accommodate a number of variants. Several combinations of the above features may be contemplated. Examples are given in the next section.

### 2. Particularly Preferred Embodiments

### 2.1 Preferred Flows of Operations

FIG. 2 shows a high-level flow of operations according to preferred embodiments. Raw KPI values are continually collected S5 with a view to forming KPIs as timeseries. Raw KPI values are recurrently buffered S10 and then preprocessed S20. A preferred preprocessing pipeline S20 is the following. The KPIs accessed are first rescaled to the range [0, 1] according to a min-max method. Missing values are then imputed using cubic splines. KPIs with lowest variance are subsequently dropped, while KPIs with extreme outliers are clipped, and the trends of the KPIs are removed by first-order differencing, if necessary. Still, other preprocessing techniques may be contemplated, depending on the data types and applications. The refined KPIs are then categorized S30, e.g., by clustering them. To that aim, in each of the clusters formed, representative KPIs (central and peripheral KPIs) are selected, queued, and ordered S40 in respective buffer channels. The buffered KPIs are then injected S51 in respective input channels of the ANN 15, for it to reconstruct S55 the initial KPIs. I.e., the central and peripheral KPIs are fed S51 into respective input channels of the ANN 15, which independently processes S52 the injected KPI values in each input channel, prior to jointly processing S53-S55 the resulting values via the encoder and decoder inner layers. Namely, the ANN 15 first compresses the KPI values via the TCN blocks and then reconstruct them via the DC blocks. Reconstruction errors are computed at step S60. Time-dependent indicators are obtained at step S70, based on the reconstruction errors computed at step S60. To that aim, reconstruction errors are averaged S70 over all KPIs and smoothed over time, e.g., using a moving average function. Abnormal values of the time-dependent indicators are then identified at step S80, together with the top contributing KPIs. The latter are subsequently used to characterize S90 the target system 2, e.g., to detect a potential anomaly. A detected anomaly may, in turn, prompt support engineers to troubleshoot S90 the system 2 or, more generally, take any action with respect to system 2, e.g., to modify and improve its functioning. Meanwhile, the ANN 15 may be retrained S100, e.g., as necessary to cope with dynamically evolving conditions. This causes to update parameters (e.g., weights) of the ANN 15, which impacts subsequent reconstructions S50, and so on.

FIG. 3 shows a functional diagram of the characterization system 1. A preprocessing module 11 continually collects S5 raw KPI values. The latter are buffered S10 and preprocessed S20 to form timeseries. Refined KPI values are then categorized S30 and channeled S40 via another module 12, prior to injecting them into an ANN module 14. I.e., representative KPIs of the clusters formed at step S30 are coupled into input channels of the ANN 15, to reconstruct S50 the representative KPIs. Reconstruction errors computed in output of the ANN module 14 are then exploited by a further module 16 to characterize S90 and, if necessary, troubleshoot the system 2. Meanwhile, training data may be continually updated and stored in a dedicated storage 13, with a view to continually retraining S100 the ANN 15 and updating parameters thereof.

### 3. Technical Implementation Details

### 3.1 Computerized Units

Computerized systems and devices can be suitably designed for implementing embodiments of the present invention as described herein. In that respect, it can be appreciated that the methods described herein are largely non-interactive and automated. In exemplary embodiments, the methods described herein can be implemented either in an interactive, a partly-interactive, or a non-interactive system. The methods described herein can be implemented in software, hardware, or a combination thereof. In exemplary embodiments, the methods proposed herein are implemented in software, as an executable program, the latter executed by suitable digital processing devices. More generally, embodiments of the present invention can be implemented wherein virtual machines and/or general-purpose digital computers, such as personal computers, workstations, etc., are used.

For instance, each of the systems 1 and 2 shown in FIG. 1 may comprise one or more computerized units 101 (e.g., general- or specific-purpose computers), such as shown in FIG. 5. Each unit 101 may interact with other, typically similar units 101, to perform steps according to the present methods.

In exemplary embodiments, in terms of hardware architecture, as shown in FIG. 5, each unit 101 includes at least one processor 105, and a memory 110 coupled to a memory controller 115. Several processors (CPUs, and/or GPUs) may possibly be involved in each unit 101. To that aim, each CPU/GPU may be assigned a respective memory controller, as known per se.

One or more input and/or output (I/O) devices 145, 150, 155 (or peripherals) are communicatively coupled via a local input/output controller 135. The I/O controller 135 can be coupled to or include one or more buses and a system bus 140, as known in the art. The I/O controller 135 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processors 105 are hardware devices for executing software, including instructions such as coming as part of computerized tasks triggered by machine learning algorithms. The processors 105 can be any custom made or commercially available processor(s). In general, they may involve any type of semiconductor-based microprocessor (in the form of a microchip or chip set), or more generally any device for executing software instructions, including quantum processing devices.

The memory 110 typically includes volatile memory elements (e.g., random-access memory), and may further include nonvolatile memory elements. Moreover, the memory 110 may incorporate electronic, magnetic, optical, and/or other types of storage media.

Software in memory 110 may include one or more separate programs, each of which comprises executable instructions for implementing logical functions. In the example of FIG. 5, instructions loaded in the memory 110 may include instructions arising from the execution of the computerized methods described herein in accordance with exemplary embodiments. The memory 110 may further load a suitable operating system (OS) 111. The OS 111 essentially controls the execution of other computer programs or instructions and provides scheduling, I/O control, file and data management, memory management, and communication control and related services.

Possibly, a conventional keyboard and mouse can be coupled to the input/output controller 135. Other I/O devices 140-155 may be included. The computerized unit 101 can further include a display controller 125 coupled to a display 130. The computerized unit 101 may also include a network interface or transceiver 160 for coupling to a network (not shown), to enable, in turn, data communication to/from other, external components, e.g., other units 101.

The network transmits and receives data between a given unit 101 and other devices 101. The network may possibly be implemented in a wireless fashion, e.g., using wireless protocols and technologies, such as Wifi, WiMax, etc. The network may notably be a fixed wireless network, a wireless local area network (LAN), a wireless wide area network (WAN), a personal area network (PAN), a virtual private network (VPN), an intranet or other suitable network system and includes equipment for receiving and transmitting signals. Preferably though, this network should allow very fast message passing between the units.

The network can also be an IP-based network for communication between any given unit 101 and any external unit, via a broadband connection. In exemplary embodiments, network can be a managed IP network administered by a service provider. Besides, the network can be a packet-switched network such as a LAN, WAN, Internet network, an Internet of things network, etc.

### 3.2 Computer Program Products

The present invention may be a method, and/or a computer program product. The computer program product may include a computer readable storage medium (or media) having computer readable program instructions thereon for causing processors to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, systems, and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### 3.3 Clouds

It is to be understood that although this disclosure refers to embodiments involving cloud computing, implementation of the teachings recited herein are not limited to a cloud computing environment. Rather, embodiments of the present invention are capable of being implemented in conjunction with any other type of computing environment now known or later developed. Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service.

While the present invention has been described with reference to a limited number of embodiments, variants, and the accompanying drawings, it will be understood by those skilled in the art that various changes may be made, and equivalents may be substituted without departing from the scope of the present invention. In particular, a feature (device-like or method-like) recited in a given embodiment, variant or shown in a drawing may be combined with or replace another feature in another embodiment, variant, or drawing, without departing from the scope of the present invention. Various combinations of the features described in respect of any of the above embodiments or variants may accordingly be contemplated, that remain within the scope of the appended claims. In addition, many minor modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims. In addition, many other variants than explicitly touched above can be contemplated.

What is claimed is:

1. A computer-implemented method of characterizing a computerized system, wherein the method comprises:
accessing key performance indicators, or KPIs, for the computerized system, where each of the KPIs is a timeseries of KPI values and is categorized into one of n types of KPIs, where n≥2;
channeling KPI values of the KPIs through n buffer channels, in accordance with the n types, whereby each of the n buffer channels buffers KPI values of KPIs of a respective one of the n types;
obtaining reconstructions errors by feeding initial KPI values, as buffered in the n buffer channels, to n respective input channels of a cognitive model,
wherein the cognitive model is implemented as an autoencoder by a trained neural network, the autoencoder including an encoder with temporal convolutional layer blocks connected by each of the n input channels and a decoder comprising deconvolution layer blocks connected by the encoder,
whereby the initial KPI values are independently processed in the n input channels, then compressed via the temporal convolutional layer blocks of the encoder, prior to being reconstructed via the deconvolution layer blocks of the decoder, and the reconstruction errors are obtained by comparing the reconstructed KPI values with the initial KPI values; and
characterizing the computerized system based on the reconstruction errors obtained.

2. The method according to claim 1, wherein:
the method further comprises obtaining time-dependent indicators based on the reconstruction errors obtained and identifying abnormal values of the time-dependent indicators; and
the computerized system is characterized based on a selection of the KPIs that contribute the most to the abnormal values identified.

3. The method according to claim 2, wherein:
obtaining the time-dependent indicators includes summing the reconstructions errors obtained for the KPI values over all of the KPIs, for each time point of the time points spanned by the KPIs; and
said abnormal values are identified by identifying critical time points of the time points, at which the time-dependent indicators exceed a threshold value.

4. The method according to claim 3, wherein
the reconstruction errors are obtained by computing distances between the reconstructed KPI values and the initial KPI values, for each of the KPIs and for each of the time points; and
obtaining the time-dependent indicators further includes smoothing the summed reconstructions errors over time, such that
the time-dependent indicators are obtained as smoothed values for each of the time points, and
the critical time points identified correspond to time points at which the smoothed values exceed said threshold value.

5. The method according to claim 4, wherein
the time points are identified according to a K-sigma thresholding method, based on a mean value and a dispersion value obtained for the smoothed values.

6. The method according to claim 1, wherein
each of the n input channels comprises one or more depth-wise convolutional layers, or DWC layers, and
the initial KPI values are independently processed in the n input channels by performing depth-wise spatial convolutions separately on each of the n input channels, thanks to said DWC layers.

7. The method according to claim 6, wherein
the method further comprises, prior to accessing the KPIs, training the cognitive model based on initial weights that are differently scaled in the DWC layers of the n input channels.

8. The method according to claim 1, wherein
the encoder includes two temporal convolutional layer blocks and the decoder includes two deconvolutional layer blocks.

9. The method according to claim 8, wherein
each of the two temporal convolutional layer blocks comprises one or more dilated temporal convolutional filter layers.

10. The method according to claim 9, wherein
each of the two temporal convolutional layer blocks further comprises, in output of the dilated temporal convolutional filter layers, a batch normalization layer, an activation layer, and a spatial dropout layer.

11. The method according to claim 1, wherein the method further comprises, prior to channeling the KPI values:
clustering the KPIs to obtain k clusters, each including at least m KPIs, where m>n and k>2; and
for each cluster of the k clusters obtained, identifying n representative KPIs in said each cluster as objects of the n respective types, respectively, wherein the n representative KPIs identified for said each cluster include a central KPI and a peripheral KPI.

12. The method according to claim 11, wherein
n=2, such that the n buffer channels consists of two buffer channels, including a first buffer channel and a second buffer channel, and the input channels of the neural network consists of two input channels, including a first input channel and a second input channel, and
the two representative KPIs identified for said each cluster consist of the central KPI and the peripheral KPI, whereby central KPIs of the k clusters are buffered in the first buffer channel and fed into the first input channel, while peripheral KPIs of the k clusters are buffered in the second buffer channel and fed into the second input channel.

13. The method according to claim 1, wherein
characterizing the state of the computerized system comprises detecting an anomaly in the system, based on the reconstruction errors produced.

14. The method according to claim 13, wherein
characterizing the state of the computerized system further comprises instructing to take action in respect of the computerized system, based on the reconstruction errors produced, so as to modify a functioning of the computerized system.

15. The method according to claim 13, wherein
characterizing the state of the computerized system further comprises troubleshooting the computerized system by analyzing only a selection of the KPIs, the latter identified based on the reconstruction errors obtained.

16. The method according to claim 1, wherein
the method further comprises, prior to channeling the data, collecting KPI values based on data streams of data collected from the computerized system and aggregating the KPI values computed to form said KPIs as timeseries.

17. A characterization system for characterizing a computerized system, wherein the characterization system comprises:
a communication unit configured to access data from the computerized system; and
a processing unit connected to the communication unit and configured to :
access key performance indicators, or KPIs, for the computerized system, where each of the KPIs is a timeseries of KPI values and is categorized into one of n types of KPIs, where n>2;
channel KPI values of the KPIs through n buffer channels, in accordance with the n types, whereby each of the n buffer channels buffers KPI values of KPIs of a respective one of the n types;
obtain reconstructions errors by feeding initial KPI values, as buffered in the n buffer channels, to n respective input channels of a cognitive model,
wherein the cognitive model is implemented as an autoencoder by a trained neural network, the autoencoder including an encoder with temporal convolutional layer blocks connected by each of the n input channels and a decoder comprising deconvolution layer blocks connected by the encoder,
whereby, in operation, the initial KPI values are independently processed in the n input channels, then compressed via the temporal convolutional layer blocks of the encoder, prior to being reconstructed via the deconvolution layer blocks of the decoder, and the reconstruction errors are obtained by comparing the reconstructed KPI values with the initial KPI values; and
characterize the computerized system based on the reconstruction errors obtained.

18. The characterization system according to claim 17, wherein
each of the n input channels comprises one or more depth-wise convolutional layers, or DWC layers, whereby, in operation, the initial KPI values are independently processed in the n input channels by performing depth-wise spatial convolutions separately on each of the n input channels, thanks to said DWC layers.

19. The system according to claim 18, wherein
the encoder includes two temporal convolutional layer blocks and the decoder includes two deconvolutional layer blocks,
each of the two temporal convolutional layer blocks comprises one or more dilated temporal convolutional filter layers, and
each of the two temporal convolutional layer blocks further comprises, in output of the dilated temporal convolutional filter layers, a batch normalization layer, an activation layer, and a spatial dropout layer.

20. A computer program for characterizing a computerized system, the computer program product comprising a computer readable storage medium having program instructions embodied therewith, the program instructions executable by processing means to cause the latter to:
access key performance indicators, or KPIs, for the computerized system, where each of the KPIs is a timeseries of KPI values and is categorized into one of n types of KPIs, where n≥2;
channel KPI values of the KPIs through n buffer channels, in accordance with the n types, whereby each of the n buffer channels buffers KPI values of KPIs of a respective one of the n types;
obtain reconstructions errors by feeding initial KPI values, as buffered in the n buffer channels, to n respective input channels of a cognitive model,
wherein the cognitive model is implemented as an autoencoder by a trained neural network, the autoencoder including an encoder with temporal convolutional layer blocks connected by each of the n input channels and a decoder comprising deconvolution layer blocks connected by the encoder,
whereby, in operation, the initial KPI values are independently processed in the n input channels, then compressed via the temporal convolutional layer blocks of the encoder, prior to being reconstructed via the deconvolution layer blocks of the decoder, and the reconstruction errors are obtained by comparing the reconstructed KPI values with the initial KPI values; and
characterize the computerized system based on the reconstruction errors obtained.
